(19) United States
(12) Patent Application Publication
(10) Pub. No.: US 2012/0150749 A1
(43) Pub. Date: Jun. 14, 2012

(54) METHOD AND SYSTEM FOR SECURING PIN ENTRY ON A MOBILE PAYMENT DEVICE UTILIZING A LOCKED BUFFER

(75) Inventor: Paul D. Coppinger, Scottsdale, AZ (US)

(73) Assignee: APRIVA, LLC, Scottsdale, AZ (US)

(21) Appl. No.: 13/396,967

(22) Filed: Feb. 15, 2012

Related U.S. Application Data
(63) Continuation of application No. 12/119,417, filed on May 12, 2008.

(51) Int. Cl. G06Q 20/40; G06Q 20/32

(52) U.S. Cl. 705/71; 705/72; 705/76

(57) ABSTRACT

A mobile communication device 130 obtains a password of a customer for processing a payment transaction. The mobile communication device 130 stores the password in volatile memory in a buffer that is locked to prevent transference into a nonvolatile medium. The mobile communication device encrypts the password using a public key and then erases the unencrypted password from the buffer in volatile memory after the encrypted password is created. The mobile communication device 130 transfers the encrypted password over a network 140 to a transaction host 160 that utilizes the password in performing the payment transaction.

### CROSS REFERENCE TO RELATED APPLICATIONS

This application claims priority to, and is a continuation of U.S. Ser. No. 12/119,417 filed on May 12, 2008, entitled “METHOD AND SYSTEM FOR SECURING A PAYMENT TRANSACTION”. The entire contents of the foregoing application is hereby incorporated by reference.

### FIELD OF THE INVENTION

The present invention relates to data security and, more particularly, the securing of data in payment transactions.

### BACKGROUND OF THE INVENTION

A modern point of sale system typically includes a terminal which accepts payment cards such as credit and debit cards. When a product is purchased, the merchant enters product and price information into the point of sale system. The customer may then initiate payment by swiping a payment card through a card reader or providing the card for the merchant to do so. The system then communicates via network with a transaction host that authorizes and processes the transaction on behalf of a financial institution that holds the account with which the payment card is associated.

In order to authorize the transaction, some form of authentication, such as a signature or password, must be provided by the paying customer. Debit card transactions, for example, typically require the customer to provide a personal identification number (PIN) which authenticates the customer to the transaction host. The customer enters the number into a PIN Entry Device (PED) and the system then provides the PIN via network to the transaction host. The transaction host uses the PIN to confirm the identity of the user, confirms sufficient funds are available, debits the customer's account by the payment amount, and communicates approval back to the point of sale system.

As it plays a critical role in controlling access to the customer's account, it is essential for the PIN to remain confidential. For this reason, security measures are applied to ensure the PIN is not discovered during the transaction. This includes encryption of the PIN, before it is transmitted from the point of sale system to the transaction host, into a format essentially undecipherable by anyone without a corresponding decryption key.

Conventional point of sale systems have typically employed symmetric (shared) key algorithms to encrypt the PIN. That is, the PIN is encrypted by the system using a secret key and then transmitted to the transaction host where it is decrypted using a secret key that is identical to the one used to encrypt it. For some types of transactions, symmetric key encryption is required by the transaction host. Electronic Benefit Transfer (EBT) transactions, for example, require the PIN to be encrypted with a shared secret key.

Maintaining an encryption key within the point of sale system leaves it potentially vulnerable to discovery. For this reason, the secret key used to encrypt the PIN is required to reside only within the PED into which the PIN is entered, and stringent physical requirements and regulations are applied to prevent physical or electronic tampering with the PED. Such measures may be prohibitively burdensome to merchants and, even when employed, may not entirely overcome the vulnerability of the shared secret key approach.

Furthermore, utilization of the symmetric key encryption approach described above essentially limits PIN-based transactions to fixed location PEDs because the lack of physical control renders it impossible to secure a shared secret key in a mobile device.

It would therefore be desirable to provide a means for securing a payment transaction which overcomes the disadvantages inherent in the use of a symmetric key algorithm. It would also be desirable to provide a means for securing a payment transaction that utilizes a mobile device.

### BRIEF DESCRIPTION OF THE DRAWINGS

The invention is described in terms of the preferred embodiments set out below and with reference to the following drawings in which like reference numerals are used to refer to like elements throughout.

FIG. 1 is a block diagram illustrating a system in which a secure payment transaction is performed in accordance with an embodiment of the present invention.

FIG. 2 is a flow diagram illustrating a process performed by a mobile payment device to obtain a secure payment transaction in accordance with an embodiment of the present invention.

FIG. 3 is a flow diagram illustrating a process performed by a cryptographic conversion host to secure a payment transaction in accordance with and embodiment of the present invention.

FIG. 4 is a flow diagram illustrating a process performed by a transaction host to perform a secure payment transaction in accordance with an embodiment of the present invention.

### DETAILED DESCRIPTION OF THE PREFERRED EMBODIMENTS

In an embodiment of the invention described herein, a method and system are provided for securing a payment transaction. A password is obtained from a customer by a mobile payment device. The password is encrypted with a public key. The encrypted password is provided over a network and then decrypted with a corresponding private key. The password is re-encrypted with a secret key and provided to a financial host which decrypts the password with an identical secret key and applies the decrypted password to process the payment transaction.

in one aspect of this embodiment, a method of obtaining a secure payment transaction is provided in a mobile payment device such as an appropriately configured PDA or Smartphone. A password associated with a customer, such as a personal identification number, is obtained via, for example, a keypad or touchpad of the mobile payment device. The password is then encrypted with a public key such as an RSA public key. The public key encrypted password is transmitted to a host which decrypts it with a corresponding private key and re-encrypts the decrypted password with a secret key such as a Triple DES key. The host then provides the secret key encrypted password to a transaction host that decrypts it with an identical secret key and applies the decrypted password to process the payment transaction.

in another aspect of the embodiment described herein, a method for securing a payment transaction is provided by, for example, a cryptographic conversion host which obtains an encrypted password such as a personal identification number from a mobile payment device (such as a PDA or Smartphone) that has encrypted the password with a public key such as an RSA public key. The public key encrypted password is then decrypted with a corresponding private key and re-encrypted with a secret key such as a Triple DES key. The private key and secret key are, for example, generated and maintained in a hardware security module of the cryptographic conversion host. The secret key encrypted password is then provided to a transaction host which decrypts it with an identical secret key and applies the decrypted password to process the transaction.

The method and system described above provide the advantages of asymmetric key encryption to point of sale systems utilizing transaction hosts designed to accept symmetric key encrypted payment data. One advantage of enabling asymmetric key encryption in the point of sale system is that it allows for mobility of the payment device since it can utilize a public key to encrypt the payment data and is, therefore, no longer burdened with the restrictions associated with maintaining a secret key. This allows for password-based payment transactions to be performed by mobile devices such as PDAs and Smartphones, providing mobile payment capability with other practical functions in a single mobile communications device.

Such transactions may include, for example, PIN-based electronic benefit transfer (EBT) transactions, where the EBT host is configured to receive and decrypt a symmetric key encrypted PIN. An aspect of the invention thus provides the capability of mobile payment for EBT transactions by utilizing asymmetric key encryption to encrypt the PIN in the mobile payment device and then converting the asymmetric key encrypted PIN to a symmetric key encrypted PIN as expected by the EBT host.

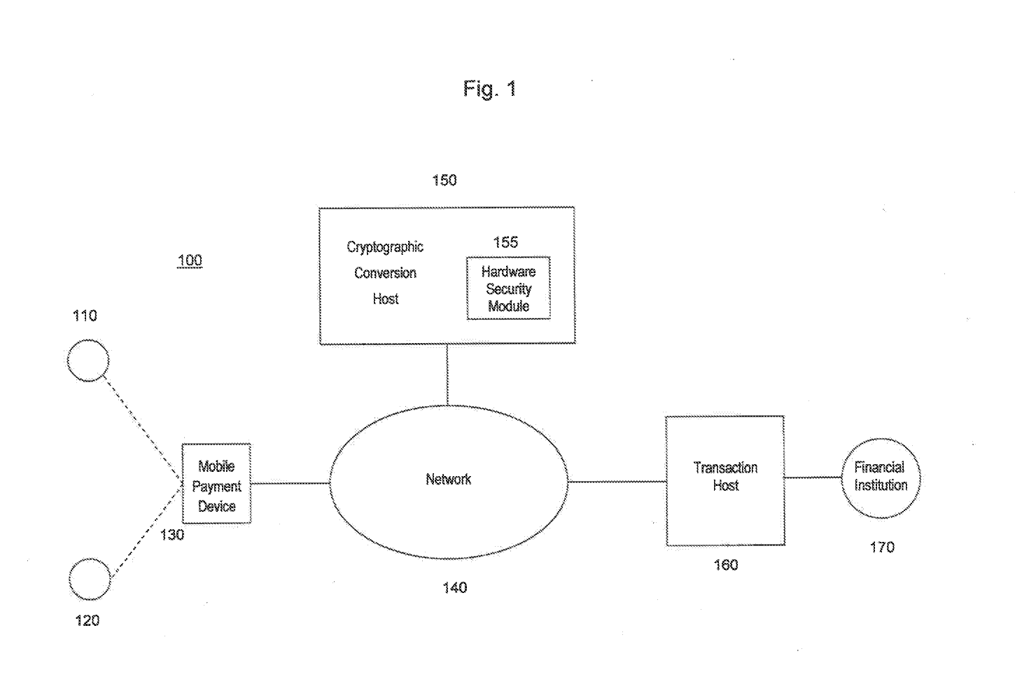

FIG. 1 is a block diagram illustrating a system in which a secure payment transaction is performed in accordance with an embodiment of the present invention. The system 100 shown in FIG. 1 provides for a secure payment transaction to be made for the sale of goods or services to a customer 110 by a merchant 120 who maintains a mobile payment device 130. The mobile payment device 130 may be, for example, a Personal Digital Assistant (PDA) or a mobile phone with advanced personal computing capabilities (Smartphone) configured to perform the payment functions described herein.

The mobile payment device 130 has a processor, volatile and nonvolatile memory, and other hardware and firmware elements operating in accordance with system and application software appropriate to the functions it provides. The mobile payment device 130 also includes a user interface with input means such as a keypad or touchpad through which information can be entered and display means such as a small display screen providing information to the user.

The mobile payment device 130 further includes a card reader through which a payment card such as a credit or debit card can be swiped. The card reader may be a magnetic stripe card reader, smart card reader, or any apparatus appropriate for reading data from a payment card. In the described embodiment, the card reader is an internal card reader included within the mobile payment device 130. Alternatively, the mobile payment device 130 can obtain the customer data from an external card reader (not shown) to which it is communicatively connected.

The system 100 includes a network 140 over which transaction data necessary to process the payment transaction is transmitted. The network 140 is any suitable telecommunications network having a wireless network component through which the mobile payment device 130 communicates, allowing the mobile payment device 130 to have mobile capability.

The system 100 is provided with a host, referred to herein as a cryptographic conversion host 150, which converts public key encrypted data into secret key encrypted data. The cryptographic conversion host 150 interfaces with the network 140 and includes a hardware security module 155 which generates and securely stores a private key it uses to decrypt the public key encrypted data and a secret key it uses to re-encrypt the decrypted data. One of ordinary skill in the art will recognize that the cryptographic conversion host 150 may be implemented in a number of different ways and may be, for example, part of a host system that performs other tasks such as data security functions.

The system 100 further includes a transaction host 160 which obtains transaction data via the network 140 and processes the payment transaction on behalf of a financial institution 170 that holds the account of the customer 110 for the payment card that has been used.

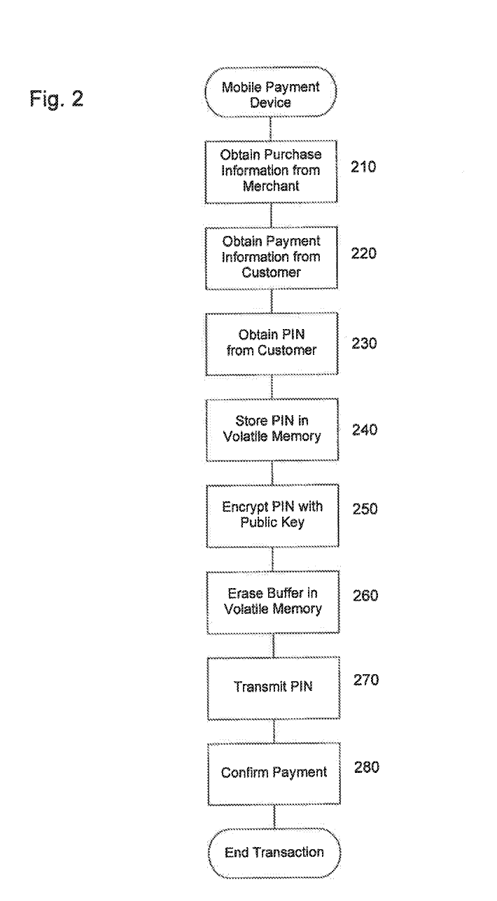

FIG. 2 is a flow diagram illustrating a process performed by the mobile payment device 130 to obtain a secure payment transaction in accordance with an embodiment of the present invention. In step 210, the mobile payment device 130 obtains from the merchant 120 purchase information such as the price of goods or services provided to the customer 110. In step 220, the mobile payment device 130 obtains payment information from the customer 110, such as an authorization to charge the purchase to his or her payment card. For example, customer 110 swipes an Electronic Benefit Transfer (EBT) card through the card reader of the mobile payment device 130.

In step 230, the mobile payment device 130 obtains a password from the customer 110. When certain types of payment cards are utilized, some form of password must be provided by the customer 110 to authenticate the customer to the financial institution that will process the payment. For example, when a debit card or EBT card is provided, the customer 110 is typically required to provide a Personal Identification Number (PIN.) One of ordinary skill will recognize, however, that depending on the type of payment card used, the application and the circumstances, alternative types of passwords may be used including alphabetic, numeric and other characters or values, or various combinations thereof and that the present invention can be readily adapted to secure transactions utilizing such alternative types of passwords.

Continuing with the example above where an EBT card has been provided in step 220, the mobile payment device 130 in step 230 obtains a PIN from the customer 110 via the input means provided by the mobile payment device 130, such as by the customer 110 entering the PIN on a keypad or touchpad of the mobile payment device 130.

In step 240, the mobile payment device 130 stores the PIN obtained from the customer 110 in volatile memory within the mobile payment device 130, in one advantageous embodiment, the PIN is stored in a buffer within the volatile memory that is locked to prevent any transference into a nonvolatile medium.

In step 250, the mobile payment device 130 encrypts the PIN using an asymmetric (public key) cryptography algorithm. In an embodiment of the invention, the mobile payment device 130 applies an RSA algorithm utilizing Public Key Cryptography Standard (PKCS) #1 as defined by RSA Laboratories. Specifically, the mobile payment device 130 maintains an RSA public key previously generated by the hardware security module 155 of the cryptographic conversion host 150 which also generated and continues to maintain the corresponding RSA private key. The mobile payment device 130 places the PIN into the message portion of a PKCS #1 Type 2 encryption block and applies the RSA public key to encrypt the block. Immediately thereafter, in step 260, the mobile payment device 130 erases the buffer in volatile memory in which the unencrypted PIN was stored.

In step 270, the mobile payment device 130 transmits the public key encrypted PIN via the network 140 to the cryptographic conversion host 150. Specifically, the mobile payment device 130 places the RSA public key encrypted PIN block into a transaction message and then transmits the transaction message to the cryptographic conversion host 150. One of ordinary skill will recognize that the transaction message could be implemented in a variety of ways. The transaction message can be, for example, an ISO 8583 message which contains the PIN block along with other data related to the transaction.

The mobile payment device 130 and cryptographic conversion host 150 secure the transmission using a cryptographic protocol such SSL 3.0 (Secure Sockets Layer version 3.0) which provides various security features including encryption, authentication and data integrity. One of ordinary skill will recognize that available protocols may change and improve over time, and will apply a means of securing the transmission that is appropriate for the application and circumstances at hand.

Thereafter, in step 280, the mobile payment device 130 awaits an acknowledgement of successful processing of the payment transaction and displays a confirmation to the user that the transaction has been completed. It should be understood in accordance with the above description that the mobile payment device 130 contains only the public key and not the corresponding private key. As a result, the mobile payment device 130 is not vulnerable to compromise of a key used to decrypt the PIN, as has been the case for conventional PEDs which use a symmetric (shared secret key) cryptography algorithm.

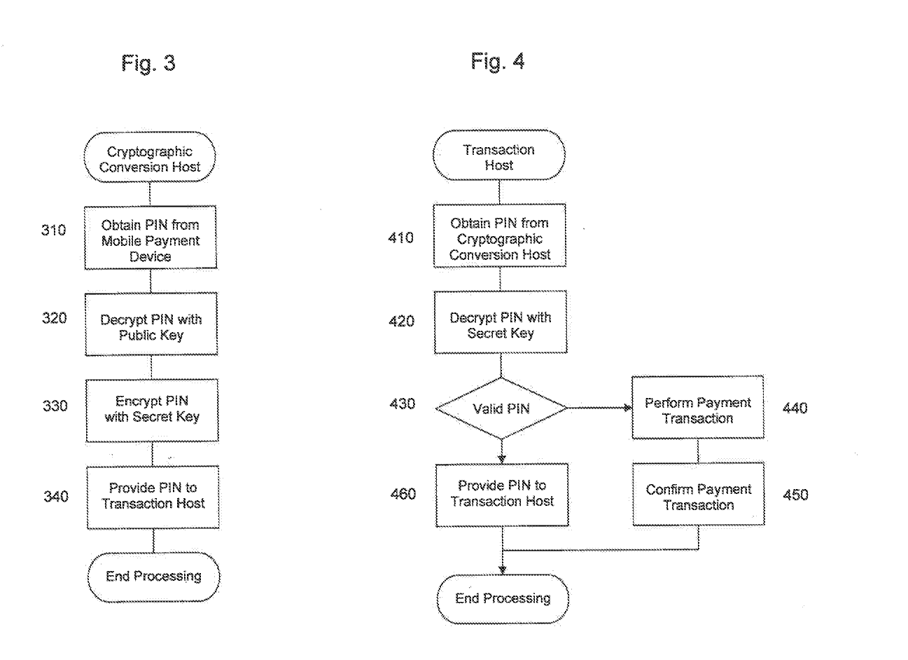

FIG. 3 is a flow diagram illustrating a process performed by the cryptographic conversion host 150 to secure a payment transaction in accordance with a specific embodiment of the present invention. In step 310, the cryptographic conversion host 150 obtains the public key encrypted PIN from the mobile payment device 130 via the network 140. Specifically, the cryptographic conversion host 150 obtains the transaction message described above from the mobile payment device 130 and extracts the RSA public key encrypted PIN block. The cryptographic conversion host 150 then passes the public key encrypted PIN block to the hardware security module 155.

In step 320, the cryptographic conversion host 150 decrypts the public key encrypted PIN. The hardware security module 155 securely maintains an RSA private key which corresponds to the RSA public key that was used by the mobile payment device 130 to encrypt the PIN. The hardware security module 155 applies the RSA private key to decrypt the RSA public key encrypted PIN block and extracts the PIN from the resulting decrypted PKCS #1 Type 2 encryption block.

In step 330, the cryptographic conversion host 150 re-encrypts the PIN using an asymmetric (secret key) cryptography algorithm. In an embodiment of the invention, the cryptographic conversion host 150 applies a Triple Data Encryption Standard (3DES) algorithm to encrypt the PIN. The hardware security module 155 securely maintains a 3DES secret key which is identical to a secret key maintained by the transaction host 160. The identical secret keys are generated, for example, by a Derived Unique Key Per Transaction (DUKPT) process. The hardware security module 155 applies the 3DES secret key to encrypt the PIN, placing it into an encrypted PIN block and then passing the encrypted PIN block back to the cryptographic conversion host 150.

In step 340, the cryptographic conversion host 150 replaces the RSA encrypted PIN block in the transaction message with the 3DES secret key encrypted PIN block and provides the transaction message to the transaction host 160. For example, the cryptographic conversion host 150 transmits the transaction message with the 3DES secret key encrypted PIN block to the transaction host 160 via the network 140.

FIG. 4 is a flow diagram illustrating a process performed by a transaction host to perform a secure payment transaction in accordance with the present invention. In step 410, the transaction host 160 obtains the secret key encrypted PIN from the cryptographic conversion host 150. Specifically, the transaction host 160 obtains the transaction message described above via, for example, the network 140 and extracts the secret key encrypted PIN block from the transaction message.

In step 420, the transaction host 160 decrypts the secret key encrypted PIN block. Specifically, the transaction host 160 stores a 3DES secret key that is identical to the 3DES secret key applied by the cryptographic conversion host 150 to encrypt the PIN block. The transaction host 160 applies the 3DES secret key to decrypt the 3DES secret key encrypted PIN block and extracts the PIN from the decrypted PIN block.

In step 430, the transaction host 160 determines whether the PIN is valid by comparing it to data associated with the account of the customer 110 the particular transaction. If the PIN is valid, the transaction host 160 performs the transaction in step 450, debiting the account of the customer 110 by the purchase amount, and confirms the transaction in step 460, sending an appropriate confirmation message back to the mobile payment device 130 via the network 140. If the PIN is not valid, the transaction host 160 sends a rejection message back to the mobile payment device 130 via the network 140.

The invention has been described above with reference to one or more illustrative embodiments. Based on this description, further modifications and improvements may occur to those skilled in the art. The claims are intended to cover all such modifications and changes as fall within the scope and spirit of the invention.

What is claimed is:

1. A method for securing a payment transaction, the method performed by a mobile communication device and comprising the steps of:
obtaining, via entry into the mobile communication device, a personal identification number (PIN) of a customer;
storing the PIN in a volatile memory in a buffer that is locked to prevent transference into a nonvolatile medium;
transferring the PIN over a network to a transaction host which utilizes the PIN in performing the payment transaction for the customer; and
erasing the PIN from the buffer in the volatile memory.

2. The method of claim 1, further comprising the step of encrypting the PIN to create an encrypted PIN, and wherein the step of transferring the PIN comprises transferring the encrypted PIN over the network.

3. The method of claim 2 wherein the step of erasing the PIN comprises erasing the PIN from the buffer in the volatile memory immediately after the encrypted PIN is created.

4. The method of claim 2 wherein the step of encrypting the PIN comprises encrypting the PIN with a public key.

5. The method of claim 1, further comprising the step of obtaining an authorization from the transaction host to perform the transaction based on acceptance of the PIN.

6. A mobile communication device configured for securely performing a payment transaction, the mobile communication device comprising:
an input means for obtaining a personal identification number (PIN) of a customer;
a volatile memory storing the PIN in a buffer that is locked to prevent transference into a nonvolatile medium;
transfer means for transferring the PIN over a network to a transaction host which utilizes the PIN in performing the payment transaction for the customer; and
means for erasing the PIN from the buffer in the volatile memory.

7. The mobile communication device of claim 6, further comprising encryption means for encrypting the PIN before it is transferred by the transfer means.

8. The mobile communication device of claim 7 wherein the encryption means comprises public key encryption means for encrypting the PIN with a public key.

9. The mobile communication device of claim 6 wherein the mobile communication device is a mobile phone.

10. The mobile communication device of claim 6 wherein the mobile communication device is a personal digital assistant.

11. A method for securing a payment transaction, the method performed by a mobile communication device and comprising the steps of:
obtaining, via entry into the mobile communication device, a password of a customer;
storing the password in a volatile memory in a buffer that is locked to prevent transference into a nonvolatile medium;
transferring the password over a network to a transaction host which utilizes the password in performing the payment transaction for the customer; and
erasing the password from the buffer in the volatile memory.

12. The method of claim 11, further comprising the step of encrypting the password to create an encrypted password, and wherein the step of transferring the password comprises transferring the encrypted password over the network.

13. The method of claim 12 wherein the step of erasing the password comprises erasing the password from the buffer in the volatile memory immediately after the encrypted password is created.

14. The method of claim 12 wherein the step of encrypting the password comprises encrypting the password with a public key.

15. The method of claim 11, further comprising the step of obtaining an authorization from the transaction host to perform the transaction based on acceptance of the password.

16. A mobile communication device configured for securely performing a payment transaction, the mobile communication device comprising:
an input means for obtaining a password of a customer;
a volatile memory storing the password in a buffer that is locked to prevent transference into a nonvolatile medium;
transfer means for transferring the password over a network to a transaction host which utilizes the password in performing the payment transaction for the customer; and
means for erasing the password from the buffer in the volatile memory.

17. The mobile communication device of claim 16, further comprising encryption means for encrypting the password before it is transferred by the transfer means.

18. The mobile communication device of claim 17 wherein the encryption means comprises public key encryption means for encrypting the password with a public key.

19. The mobile communication device of claim 16 wherein the mobile communication device is a mobile phone.

20. The mobile communication device of claim 16 wherein the mobile communication device is a personal digital assistant.
